(19) United States
(12) Patent Application Publication
(10) Pub. No.: US 2024/0089556 A1
(43) Pub. Date: Mar. 14, 2024

(54) SYSTEM AND METHOD FOR IMPROVED DETERMINATION OF UNIVERSAL LOW NOISE BLOCK SATELLITE INTERFACE TYPE

(71) Applicant: ARRIS ENTERPRISES, LLC, Suwanee, GA (US)

(72) Inventors: Paul Richard PRATT, Wakefield (GB); Robert Michael PAYNE, Keighley (GB)

(21) Appl. No.: 18/273,599

(22) PCT Filed: Jan. 28, 2021
(86) PCT No.: PCT/US21/15419

§ 371 Date: Jul. 21, 2023

(51) Int. Cl. H04N 21/61; H04N 21/462

(52) U.S. Cl. CPC H04N 21/6193; H04N 21/4622

(57) ABSTRACT

A system and method enabling the automated installation and configuration of universal low noise block satellite system premises devices. The system and method utilize a pre-programmed series of tests to systematically test for and recognize the availability and viability of particular interface connections, and then responsively configure and install a premises device. The system and method are also adapted to provide a consumer and/or satellite service provider with feedback regarding the installation and the connection of interface cables.

### BACKGROUND OF THE INVENTION

Satellite provision of broadband media remains a popular option for consumers, especially those who find themselves in markets that are underserved by terrestrial broadband providers. A typical consumer system would consist of an external dish antenna, a signal upconverter/downconverter (usually co-located with the dish), and a premises device (a “set-top box”) incorporating a tuner, a user interface and a video output.

Broadband service providers, including satellite service providers, increasingly rely upon the consumer for installation of the set-top box. This reliance offers the consumer the flexibility of upgrading or replacing a set-top box without scheduling a service call, and reduces the burden placed upon service provider technicians. Although such do-it-yourself installation of set-top boxes offers advantages to both the consumer and the service provider, satellite system set-top boxes can pose a particular technical challenge for untrained consumers.

Presently, satellite broadband systems can connect to a set-top box via several different types of cable interfaces, including the universal low-noise block (“ULNB”) interface. This type of interface can utilize either one or two RF connections to the set-top box. To an untrained consumer presented with one or more unlabeled cables and a set-top box having any number of input and/or output jacks, the installation of a satellite set-top box could prove a confusing task. Such confusion is likely to result in an improper or at the very least sub-optimal installation, causing loss or limitation of service, consumer dissatisfaction, and the possible need for the service provider to dispatch a technician to correct the problem. All undesirable outcomes for both the consumer and the provider.

To further complicate the matter, some ULNB set-top boxes which would offer optimal performance when connected to two RF cables, will still provide a limited number of service options to a consumer when connected to only a single RF cable. This limited operability may lead an uninformed consumer to wrongly assume that the limited service is all the set-top box can provide and result in the set-top box never being properly installed.

A system and method for an improved automated process enabling the installation of satellite system consumer premises devices, such as set-top boxes, was disclosed in commonly-assigned Patent Application No. PCT/US20/35965, filed on Jun. 3, 2020. However, even the automated process described in the referenced patent application can be further improved upon so as to provide a better system and process for detecting and configuring an optimal ULNB interface for a consumer premises device, such as a set-top box.

### BRIEF SUMMARY OF THE INVENTION

A system and method enabling the automated installation and configuration of universal low noise block satellite system premises devices. The system and method utilize a pre-programmed series of tests to systematically test for and recognize the availability and viability of particular interface connections, and then responsively configure and install a premises device. The system and method are also adapted to provide a consumer and/or satellite service provider with feedback regarding the installation and the connection of interface cables.

### BRIEF DESCRIPTION OF THE DRAWINGS

The aspects, and advantages of the present invention will become better understood with regard to the following description, appended claims, and accompanying drawings in which:

FIG. 1A is a diagram of a representation of the rear panel of a first satellite set-top having a single female radio-frequency input connector and RF cables adapted to connect thereto.

FIG. 1B is a diagram of a representation of the rear panel of a first satellite set-top having two female radio-frequency input connectors and RF cables adapted to connect thereto.

FIG. 2 is a functional block diagram of a system supporting the implementation of a pre-programmed installation sequence in accordance with an embodiment of the invention.

FIG. 3 is a flow diagram of a process implementing a pre-programmed installation sequence within the system of FIG. 2.

### DETAILED DESCRIPTION

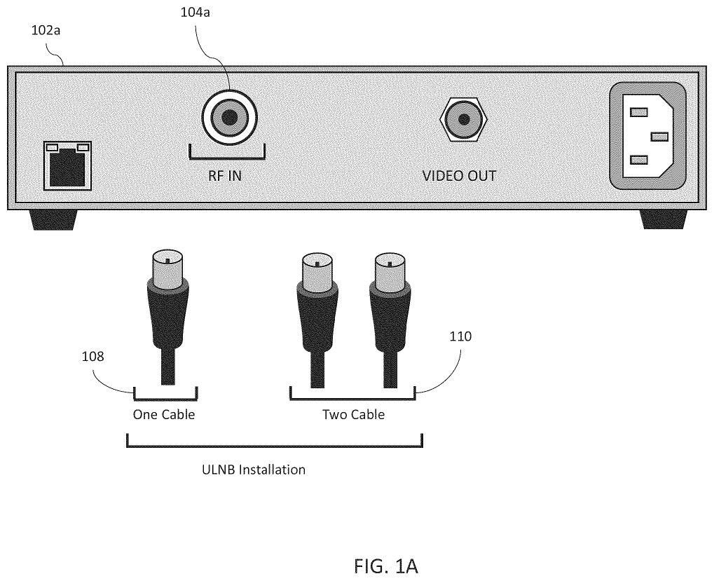

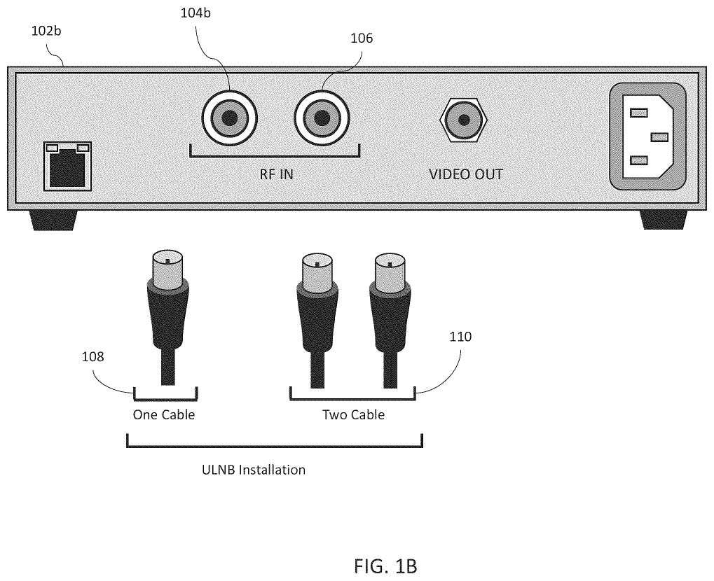

The operation of ULNB set-top boxes is typically governed by an internal controller comprised of at least one processor and associated memory. FIGS. 1A and 1B provide simplified representations of the rear panel of two such a set-top boxes (102a and 102b). Set-top box 102a includes single female radio-frequency (“RF”) input connector 104a, and set-top box 102b includes two female radio-frequency (“RF”) input connectors 104b and 106. Such RF input connectors are typically adapted to accept L-band RF signals. In a given residential ULNB installation, a consumer would be required to connect one (108) or two (110) RF cables to these input connectors. Following the successful connection of the proper cable(s) to the proper input connector(s), a correctly adapted set-top box will provide the consumer with access to the appropriate broadband services.

However, to an untrained consumer, two ULNB cables (110) would likely appear identical, and perhaps give rise to confusion. In the case of set-top box 102a, a consumer might question which of the two ULNB connectors should be mated with the single RF connector (104a). In the case of set-top box 102b, a consumer might question which of the two ULNB connectors should be mated with which of the two RF connectors (104b and 106). Similarly, confusion can arise in the case where only a single ULNB cable (108) is available. A consumer might wonder which of the two inputs (104b and 106) it should it be mated with when a set-top box similar to 102b is being utilized. So as to enable and optimize the proper set-up of the set-top box and the correct and efficient provisioning of user bandwidth and services, the set-top box controller executes an automatic installation detection process as detailed below.

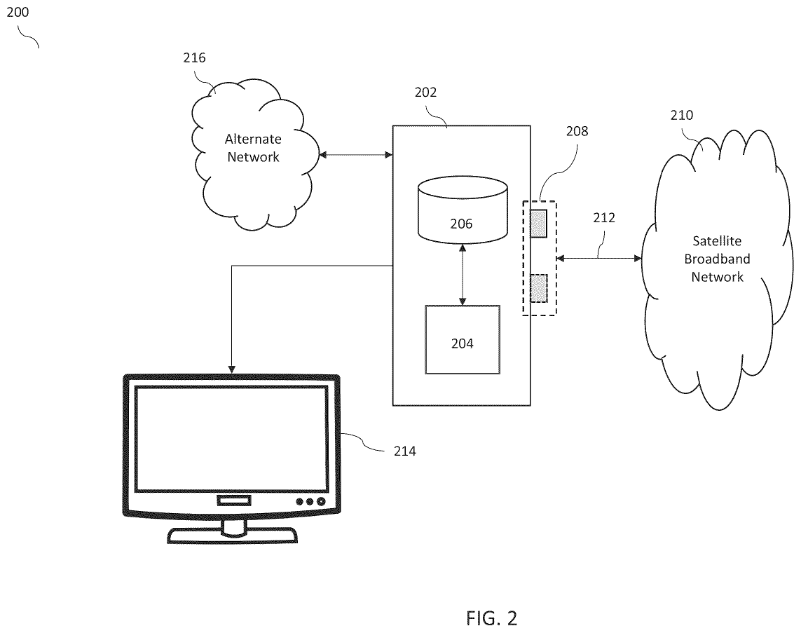

FIG. 2 provides a block diagram of a system supporting the implementation of a pre-programmed installation sequence in accordance with an embodiment of the invention. The system includes set-top box 202 (similar in configuration to set-top boxes 102a or 102b of FIGS. 1A, 1B). As shown, set-top box 202 includes processor 204 linked to memory 206. One or two RF connectors (208) that are to be linked to satellite broadband network 210 via one or two cable ULNB interface 212. Set-top box 202 is also shown to be linked to display 214 (a television, monitor, tablet or smartphone), and to alternate network 216. Alternate network 216 can be a wired or wireless network that can support a communication link to the satellite service provider (“SSP”) exclusive of satellite broadband network 210. Such a communication could be established, for example, via a telephone network (wired or cellular) or Internet connection.

Once the consumer has connected the available cable(s) to the RF connectors(s), processor 204 within set-top box 202 is initialized and a pre-programmed sequence of steps (300) is executed. This pre-programmed installation sequence is executed in accordance with instructions stored within memory 206 of satellite set-top box 202. These instructions will cause the set-top box to execute an interface detection process that tests for a limited set of specific conditions indicative of the possible types of ULNB interfaces to which the set-top box is intended to mate with. This detection process involves the set-top box sending a message in accordance with the Digital Satellite Equipment Control (“DiSEqC”) 2.0 protocol to upstream provider-controlled equipment. This signal is sent out via the set-top RF connector(s). The set-top box then determines if the upstream equipment has returned a response confirming that an RF cable providing an upstream connection is evident at a given RF connector.

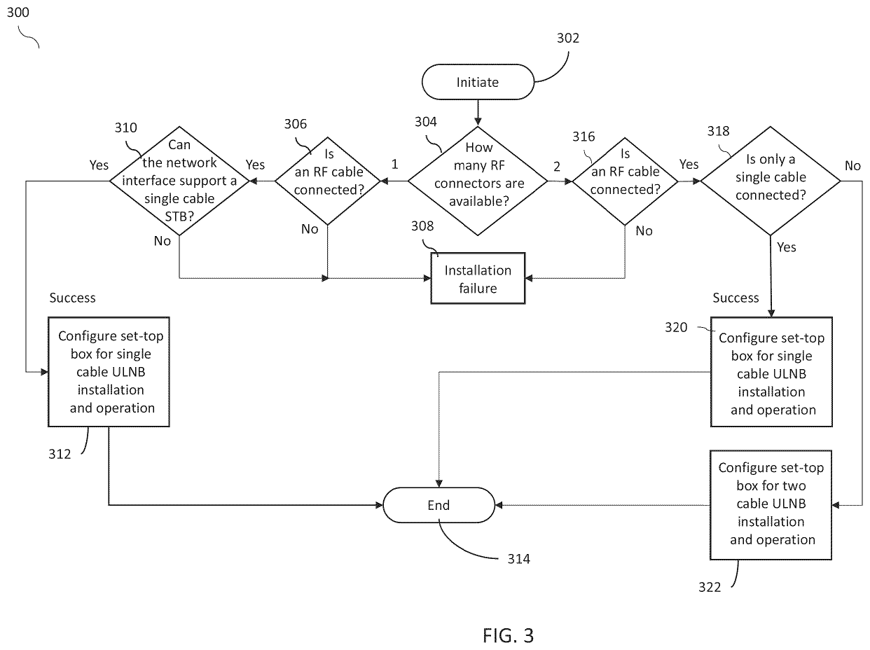

FIG. 3 provides a flow diagram of the process that would be carried by a set-top box adapted to implement a pre-programmed installation sequence in accordance with an embodiment of the invention. Upon initialization (step 302), a processor within the set-top box retrieves instructions for the performance of interface tests to determine the type of interface to which the set-top box is mated. The first test to be performed (step 304) determines how many RF connectors are available upon the set-top box. If the set-top box is similar to set-top box 102a, the process would continue with step 306, wherein the processor would determine if an RF cable was connected to the single available RF connector. If that test returned a negative result, the installation process would fail (step 308). Such failure could initiate the generation of a failure message to the consumer via a display 214, or to the SSP via alternate network 216 (if such was available). If, however, the test of step 306 returns an affirmative result, the process continues with step 310, and the processor determines if the network interface (the single connected cable) is capable of supporting a set-top box with only a single RF connector. If so, the processor configures the set-top box for single cable ULNB operation (step 312) and then the installation process terminates (step 314). If step 310 returns a negative result, the installation fails (step 308).

If at step 304 the processor determines that two RF connectors are available upon the set-top box (a box similar to 102b), the process continues with step 316, wherein the processor would determine if an RF cable was connected to either of the available RF connectors. If that test returned a negative result, the installation process would fail (step 308). If, however, the test of step 316 returns an affirmative result, the process continues with step 318, and the processor determines if only a single cable is connected to the set-top box. If so, the process then moves to step 320, wherein the set-top box is configured for single cable ULNB operation. The installation process then terminates (step 314). However, if at step 318 the processor makes a determination that there are two cables connected to the set-top box (a negative outcome at step 318), the processor configures the set-top box for two cable ULNB operation (step 322), and then terminates with step 314.

Although the invention herein has been described with reference to particular embodiments, it is to be understood that these embodiments are merely illustrative of the principles and applications of the present invention. Other embodiments and variations could be implemented without departing from the spirit and scope of the present invention as defined by the appended claims. For example, the connectors could be any type of terminal adapted for the transmission and reception of RF signals or streams, and the RF streams and signals could be of any frequency or band. Furthermore, the invention could be implemented in a single unitary device, or across multiple networked devices.

1. A system for automating the installation of a broadband satellite system premises device, comprising:
at least one terminal, adapted to receive an individual radio-frequency stream;
a memory; and
a processor adapted to:
make a first determination, based at least in part upon information stored in the memory, as to the number of available terminals adapted to receive an individual radio-frequency stream;
make a second determination as to the connection of a cable presenting an upstream connection is evident at a given available terminal; and
configure the broadband satellite system premises device for a specific installation based, at least in part, upon the first and second determinations.

2. The system of claim 1 wherein the information stored in memory is, at least in part, specified by a satellite service provider.

3. The system of claim 1 wherein the second determination is based, at least in part, upon a test performed in accordance with the Digital Satellite Equipment Control 2.0 protocol to upstream provider-controlled equipment.

4. The system of claim 1 wherein the broadband satellite premises device is a set-top box.

5. The system of claim 1 wherein the processor is further adapted to generate a message upon failure to configure the broadband satellite system premises device.

6. The system of claim 5 wherein the generated message is presented upon a display linked to the broadband satellite system premises device.

7. The system of claim 5 wherein the generated message is transmitted to a satellite services provider via an alternate network linked to the broadband satellite system premises device.

8. The system of claim 7 wherein the alternate network comprises at least one of the following:
a telephone network;
a wireless network; and
an Internet connection.

9. The system of claim 1 wherein the configuration of the broadband satellite system premises device comprises a universal low-noise block configuration.

10. The system of claim 9 wherein the universal low-noise block configuration comprises at least one of the following:
a single cable interface; and
a two cable interface.

11. A method for automating the installation of a broadband satellite system premises device, in a system comprising:
at least one terminal, adapted to receive an individual radio-frequency stream; and
a memory;
the method comprising the steps of:
making a first determination, based at least in part upon information stored in the memory, as to the number of available terminals adapted to receive an individual radio-frequency stream;
making a second determination as to the connection of a cable presenting an upstream connection is evident at a given available terminal; and
configuring the broadband satellite system premises device for a specific installation based, at least in part, upon the first and second determinations.

12. The method of claim 11 wherein the information stored in memory is, at least in part, specified by a satellite service provider.

13. The method of claim 11 wherein the second determination is based, at least in part, upon a test performed in accordance with the Digital Satellite Equipment Control 2.0 protocol to upstream provider-controlled equipment.

14. The method of claim 11 wherein the broadband satellite premises device is a set-top box.

15. The method of claim 11 wherein the processor is further adapted to generate a message upon failure to configure the broadband satellite system premises device.

16. The method of claim 15 wherein the generated message is presented upon a display linked to the broadband satellite system premises device.

17. The method of claim 15 wherein the generated message is transmitted to a satellite services provider via an alternate network linked to the broadband satellite system premises device.

18. The method of claim 17 wherein the alternate network comprises at least one of the following:
a telephone network;
a wireless network; and
an Internet connection.

19. The method of claim 11 wherein the configuration of the broadband satellite system premises device comprises a universal low-noise block configuration.

20. The method of claim 19 wherein the universal low-noise block configuration comprises at least one of the following:
a single cable interface; and
a two cable interface.
